(19) United States
(12) Patent Application Publication
(10) Pub. No.: US 2020/0059509 A1
(43) Pub. Date: Feb. 20, 2020

(54) UPLOADING A FILE FROM A USER DEVICE TO A DATA STORAGE SERVICE

(71) Applicant: Sony Mobile Communications, Inc., Tokyo (JP)

(72) Inventor: Rickard LJUNG, Helsingborg (SE)

(21) Appl. No.: 16/347,545

(22) PCT Filed: Nov. 4, 2016
(86) PCT No.: PCT/EP2016/076670

§ 371 Date: May 3, 2019

(51) Int. Cl. H04L 29/08; G06F 16/13

(52) U.S. Cl. CPC H04L 67/06; H04N 2201/0096; G06F 16/13; H04L 67/1097

(57) ABSTRACT

The present invention relates to a method for uploading a file from a user device (10) to a data storage service (20, 30, 40). According to the method, a category of a set of categories is assigned to the file based on at least one characteristic of the file characterising a content of the file. Furthermore, a data storage service (20, 30, 40) from a set of data storage services is assigned based on the assigned category and the file is uploaded to the assigned data storage service (20, 30, 40).

### FIELD OF THE INVENTION

The present invention relates to a method for uploading a file from a user device to a data storage service. The present invention relates furthermore to a user device and a server implementing the method.

### BACKGROUND OF THE INVENTION

User devices, in particular mobile devices like mobile telephones, smartphones and tablet PCs, are frequently equipped with cameras and microphones for capturing images, videos and audio information. Additionally, a user may generate other kind of information, for example documents, notices, drawings or calculations, by using applications provided on the user devices. Therefore, a large amount of user generated files relating to different areas of the user's life may reside on the user devices. For example, a collection of pictures and videos may include an amount of private and work related pictures and videos, like pictures with friends or families in different environments or pictures of work related devices and facilities. At the same time, a user of the user device may want to upload these user generated files to data storage services, for example so-called cloud data services, for storing these files, to have access to these files from other devices or for sharing these files with family members, friends or working related colleagues.

For ease of use, user devices may provide functionalities to automatically upload recently generated files. For example, recently taken pictures may be automatically uploaded to a data storage service. Examples of such services are auto upload configurations to Google photos, Facebook, Flickr, dropbox, iCloud, and Amazon Cloud Drive. However, once such an auto upload function has been configured, it will upload all new pictures to its server until inactivated by the user. If a user does not want all pictures to be automatically uploaded, for example due to privacy or work-related reasons, such an automatic upload service cannot be used.

Therefore, there is a need for an improved automatic upload service of user generated content or files.

### SUMMARY OF THE INVENTION

According to the present invention, this object is achieved by a method for uploading a file from a user device to a data storage service as defined in claim 1, a user device as defined in claim 9, and a server as defined in claim 12. The dependent claims define embodiments of the invention.

According to the present invention, a method for uploading a file or data from a user device to a data storage service is provided. The data storage service may comprise an internet hosting service specifically designed to host user files. The data storage service may comprise for example a so-called cloud storage service or an online data storage service. It allows users to upload files that could then be accessed over the Internet from a different computer, tablet, smartphone or other networked device, by the same user or possibly by other users. According to the method, a category of a set of categories is assigned to the file based on at least one characteristic of the file characterising a content of the file.

The set of categories may comprise, for example, typical areas of life of the user where the user may generate files. Examples of such categories may comprise a work related area, a family related area, a friends related area, a sporting club related area and so on.

The file or data may comprise for example an image file captured by an image capturing unit of the user device, a video file captured by a video capturing unit of the user device, an audio file recorded by an audio recording unit of the user device, or a document file containing information input via a user interface, for example a touch screen, of the user device. In particular, the file may comprise content generated at the user device upon operating the user device by the user.

Characteristics of the file may be based on the content of the file. For example, a content of a picture or an image represented by the file may be used to characterize the file. For example, the image may be analyzed by an image processing software to determine if certain persons or buildings or sites are shown in the picture as the characteristics. Likewise, a content of a video or motion picture represented by the file may be analyzed by a video processing software to determine characteristics of the file. A content of an acoustic recording represented by the file may also be analyzed by an audio processing software to determine characteristics of the file, for example if the acoustic recording comprises voices of certain persons or if the acoustic recording comprises music or people talking to each other. Furthermore, a content of textual information represented by the file may be analyzed by data processing software to characterize the file, for example keywords may be searched in the textual information to distinguish work-related information from private information. Additionally or as an alternative, so-called meta information of the file may be analyzed by a corresponding processing software to provide characteristics of the file. For example, a time and/or date information of generation of the file or a geographical place at which the file was generated may be used to characterize the file. For example, if a picture was taken at a working day between nine and five, the file may be categorized as a work-related file. On the other hand, if an image was taken at a place outside the working place, this may characterize the image as a non-working related picture. Another meta information of the file may comprise a unit information indicating a unit of the user device with which the file was generated. For example, based on the camera unit, i.e. the frontside camera on the rear side camera of the user device, with which the picture was taken and the file generated, a category may be assigned to the file.

Furthermore, according to the method, a data storage service from a set of data storage services is assigned or selected based on the assigned category. The set of data storage services may comprise data storage services related to different areas of life of the user. For example, a work related data storage service, a family data storage service, a friends data storage service and a sporting club data storage service may be provided. One or more data storage services may be assigned based on the assigned category. For example, for the friends category, the family data storage service, the friends data storage service and the sporting club data storage service may be assigned. Finally, the file is uploaded to the assigned data storage service or the plurality of assigned data storage services.

Thus, by using the above-described method, user generated information is automatically uploaded to an appropriate data storage service such that privacy and confidentiality requirements may be fulfilled.

According to an embodiment, the set of categories and the corresponding characteristics for assigning the categories are configurable by the user of the user device.

According to another embodiment, the set of data storage services and the corresponding categories for assigning the data storage services are configurable by the user of the user device.

In other words, the user may define rules and filters for controlling an automatic upload of user generated files. This may be in particular relevant for automatically uploading pictures and videos from camera equipped mobile devices.

According to another embodiment a default data storage service is assigned in case no category can be assigned to the file. The file is automatically uploaded to the default data storage service. The default data storage service may comprise, for example, a private data storage service to which only the user of the user device has access.

According to another embodiment, the file is not uploaded to any one of the set of data storage services in the case that no category can be assigned to the file. Thus, the file is kept only on the user device. In this case the file may be stored in a storage unit of the user device only. Additionally or as an alternative, in this case, the user may be automatically interrogated to assign a corresponding category, and the file may be automatically uploaded to a data storage service assigned based on the user assigned category.

Furthermore, according to an embodiment, the set of categories comprises a no-upload category which indicates that a file assigned to this no-upload category is not to be upload to any one of the set of data storage services. Upon assigning the no-upload category, the upload of the file to any one of the data storage services is inhibited. This category may be assigned for example to work related files which are generated outside the company site and no secured upload transmission to a company data storage service is available.

According to another embodiment, a user device is provided. The user device comprises a transmission interface for communicating with a data storage service, a storage unit for storing a file, and a processing unit. The processing unit is configured to assign a category of a set of categories to the file. The file may be stored in the storage unit. The assignment of the category is based on at least one characteristic of the file. The characteristic of the file characterizes a content of the file. The processing unit is furthermore configured to assign a data storage service from a set of data storage services based on the assigned category. Finally, the processing unit is configured to upload the file to the assigned data storage service via the transmission unit. The whole procedure of assigning the category, assigning the data storage service and uploading the file may be performed by the processing unit automatically upon generation of the file, for example upon taking a picture with the camera of the user device.

The user device may comprise for example a mobile telephone, a smartphone, a tablet computer, a digital camera, or a personal computer.

The user device may be configured to perform the above-described method and comprises therefore also the above-described advantages.

The set of categories may comprise, for example, typical areas of life of the user where the user may generate files. Examples of such categories may comprise a work related area, a family related area, a friends related area, a sporting club related area and so on.

The file may comprise for example an image file captured by an image capturing unit of the user device, a video file captured by a video capturing unit of the user device, an audio file recorded by an audio recording unit of the user device, or a document file containing information input via a user interface, for example a touch screen, of the user device. In particular, the file may comprise content generated at the processing unit of the user device upon operating the user device by the user.

Characteristics of the file may be based on the content of the file. For example, a content of an image represented by the file may be used to characterize the file. For example, the image may be analyzed by an image processing software executed at the processing unit of the user device to determine if certain persons or buildings or sites are shown in the picture as the characteristics. Likewise, a content of a video represented by the file may be analyzed by a video processing software executed at the processing unit of the user device to determine characteristics of the file. A content of an acoustic recording represented by the file may also be analyzed by an audio processing software executed at the processing unit of the user device to determine characteristics of the file, for example if the acoustic recording comprises voices of certain persons or if the acoustic recording comprises music or people talking to each other. Furthermore, a content of textual information represented by the file may be analyzed by data processing software executed at the processing unit of the user device to characterize the file, for example keywords may be searched in the textual information to distinguish work-related information from private information. Additionally or as an alternative, so-called meta information of the file may be analyzed by a corresponding processing executed at the processing unit of the user device to provide characteristics of the file. For example, a time and/or date information of generation of the file or a geographical place at which the file was generated may be used to characterize the file.

According to an embodiment, the processing unit of the user device is configured to receive configuration information via a user interface from the user and to configure the set of categories and the corresponding characteristics for assigning the categories based on the received configuration information.

According to another embodiment, the processing unit of the user device is configured to receive configuration information via a user interface from the user and to configure the set of data storage services and the corresponding categories for assigning the data storage services based on the received configuration information.

According to another embodiment a default data storage service is assigned by the processing unit in case no category can be assigned to the file. The file is automatically uploaded to the default data storage service.

According to another embodiment, the processing unit of the user device does not upload the file to any one of the set of data storage services in the case that the processing unit could not assign any one of the categories to the file. Additionally or as an alternative, in this case, the user may be automatically interrogated via a user interface of the user device to assign a corresponding category, and the file may be uploaded to a data storage service assigned based on the user assigned category automatically. Additionally or as an alternative, in this case the file may be stored in a storage unit of the user device only.

Furthermore, according to an embodiment, the set of categories comprises a no-upload category which indicates that a file assigned to this no-upload category is not to be uploaded to any one of the set of data storage services. This category may be assigned by the processing unit for example to work related files which are generated outside the company site where no secured upload transmission to a company data storage service is available. Upon assigning the no-upload category, the processing unit inhibits the upload of the file to any one of the data storage services.

According to another embodiment of the present invention, a server is provided comprising a first transmission interface for communicating with a user device, and a second transmission interface for communicating with a data storage service. The server comprises furthermore a processing unit which is configured to receive a file from the user device via the first transmission interface, and to assign a category of a set of categories to the file. The assignment of the category is based on at least one characteristic of the file which characterizes a content of the file. The processing unit is furthermore configured to assign a data storage service from a set of data storage services based on the assigned category, and to upload the file to the assigned data storage service via the second transmission interface.

Such a server, once configured appropriately by a user of the user device, ensures that user generated content is appropriately directed to different data storage services such that privacy and confidentiality requirements are fulfilled. Providing this processing in a server may support legacy user devices which are not capable of performing such enhanced upload functionality and/or may support users utilising a plurality of user devices to have a common data upload strategy on all utilised user devices.

According to an embodiment, the server may be configured to perform the above-described method and comprises therefore also the above-described advantages.

The set of categories may comprise, for example, typical areas of life of the user where the user may generate files.

The file may comprise for example an image file, a video file, an audio file, or a document file. In particular, the file may comprise content generated at the user device upon operating the user device by the user.

Characteristics of the file may be based on the content of the file. For example, a content of an image represented by the file may be used to characterize the file. For example, the image may be analyzed by an image processing software executed at the processing unit of the server to determine if certain persons or buildings or sites are shown in the picture as the characteristics. Likewise, a content of a video represented by the file may be analyzed by a video processing software executed at the processing unit of the server to determine characteristics of the file. A content of an acoustic recording represented by the file may also be analyzed by an audio processing software executed at the processing unit of the server to determine characteristics of the file, for example if the acoustic recording comprises voices of certain persons or if the acoustic recording comprises music or people talking to each other. Furthermore, a content of textual information represented by the file may be analyzed by data processing software executed at the processing unit of the server to characterize the file, for example keywords may be searched in the textual information to distinguish work-related information from private information. Additionally or as an alternative, so-called meta information of the file may be analyzed by a corresponding processing executed at the processing unit of the server to provide characteristics of the file. For example, a time and/or date information of generation of the file or a geographical place at which the file was generated may be used to characterize the file.

For example, the set of categories and the corresponding characteristics for assigning the categories are configurable by the user of the user device. According to an embodiment, the server is configured to receive the user configured categories via the first transmission interface.

Likewise, the set of data storage services and the corresponding categories for assigning the data storage services may be configurable by the user of the user device. According to an embodiment, the server is configured to receive the user configured data storage services and the corresponding categories via the first transmission interface.

According to another embodiment a default data storage service is assigned by the processing unit of the server in case no category can be assigned to the file and the file is automatically uploaded to the default data storage service.

According to another embodiment, the file is not uploaded to any one of the set of data storage services in the case that the processing unit of the server could not assign any one of the categories to the file. Additionally or as an alternative, in this case the file may be stored in a storage unit of the server only. Additionally or as an alternative, in this case, the server may be configured to send a request to the user device to interrogated a user to assign a corresponding category, and the file may be uploaded to a data storage service assigned based on the user assigned category automatically.

Furthermore, according to an embodiment, the set of categories comprises a no-upload category, which indicates that a file assigned to this no-upload category is not to be upload to any one of the set of data storage services. Upon assigning the no-upload category, the processing unit of the server inhibits the upload of the file to any one of the data storage services.

According to another embodiment, a system comprising a plurality of data storage services, the above-described user device and/or the above-described server is provided.

Although specific features described in the above summary and the following detailed description are described in connection with specific embodiments and aspects of the present invention, it should be noticed that the features of the exemplary embodiments and aspects described herein may be combined with each other unless specifically noted otherwise.

### BRIEF DESCRIPTION OF THE DRAWINGS

The present invention will now be described in more detail with reference to the accompanying drawings.

FIG. 1 shows schematically a user device according to an embodiment of the present invention in connection with data storage services.

FIG. 2 shows method steps of a method according to an embodiment of the present invention.

FIG. 3 shows schematically a server according to an embodiment of the present invention in connection with a user device and data storage services.

### DETAILED DESCRIPTION OF EMBODIMENTS

In the following, exemplary embodiments of the present invention will be described in more detail. It is to be understood that the features of the various exemplary embodiments described herein may be combined with each other unless specifically noted otherwise. Any coupling between components or devices shown in the figures may be a direct or indirect coupling unless specifically noted otherwise. Same reference signs in the various drawings refer to similar or identical components.

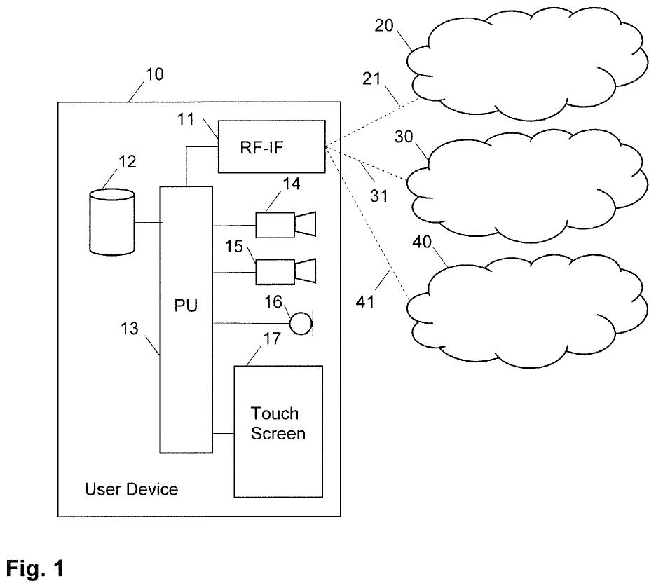

FIG. 1 shows schematically a user device 10 which may communicate with several data storage services 20, 30 and 40 via corresponding communication connections 21, 31 and 41, respectively. The user device 10 may comprise for example a mobile telephone, in particular a so-called smartphone, a tablet PC, a notebook PC or a personal computer. The user device 10 comprises a transmission interface 11 for communicating with the several data storage services 20, 30 and 40. For example, the transmission interface 11 may comprise a wireless radio frequency interface (RF-IF) operating for example according to a cellular communication standard like GSM or LTE, or according to a wireless local area network (WLAN) standard. However, the transmission interface 11 may also comprise a wired interface, for example an interface to a local area network (LAN). The user device 10 comprises furthermore a processing unit (PU) 13 and a storage unit 12. The processing unit 13 may comprise one or more microprocessors or controllers on which computer programs, so-called applications or apps, may be executed. The computer programs and corresponding information may be stored in the storage unit 12. The user device 10 may comprise furthermore input and output devices for visual, acoustic and tactile inputs and outputs. In particular, the user device 10 may comprise two cameras 14, 15, for example a front side camera 14 and a rear side camera 15, a microphone 16 and a touch screen 17.

A user who operates the user device 10 may capture pictures or videos with the cameras 14, 15, record audio sounds, music or speech with the microphone 16, and may enter information, for example notices, text or calculations via the touchscreen 17. This user generated content may be stored in corresponding files in the storage unit 12.

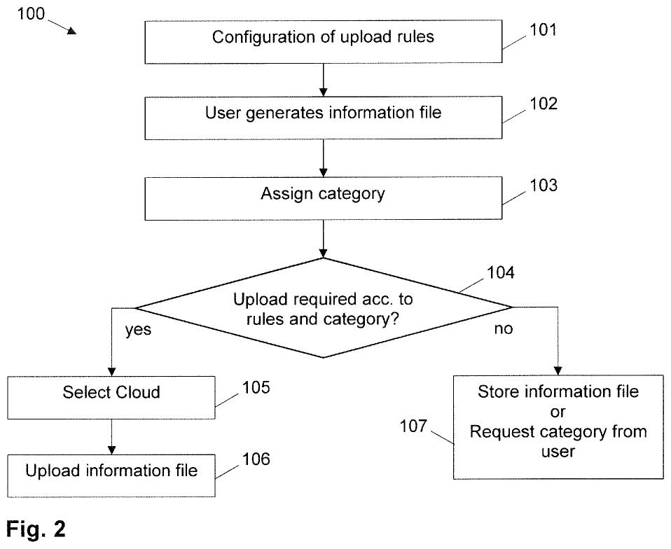

The user may want to share or save information generated with the user device 10 by automatically uploading corresponding files to one or more of the available data storage services 20, 30 and 40. However, automatically uploading user generated files may raise problems. For example, an automatic upload of newly taken pictures to a public data storage service like Facebook or Google may be configured. This may be appropriate for photos of landscapes or buildings taken during travel. However, the user may not want to automatically upload pictures containing family members or work-related content, for example an image of an industrial facility visited by the user or an image of a whiteboard content taken by the user at a work-related meeting. Therefore, the processing unit 13 is configured to perform a method 100 which will be described in more detail in connection with FIG. 2 in the following.

The method 100 comprises method steps 101 to 107 which may be coded in a software and executed by the processing unit 13. In step 101 the user may configure upload rules for the automatic upload of user generated content to the data storage services 20, 30 and 40. For example, the user may define characteristics upon which a category is assigned to a user generated content which may be stored in a corresponding file in the storage unit 12. A set of different categories may be defined, for example a category for work-related content, a category for family-related content, a category for sports club related content, and a category for content which may be posted to the public. The characteristics may comprise, for example, if an image or video content shows family members or views of the user's home, or at which geographical location the image or video content has been captured, for example near the user's home or near the user's working place, or if the image video content shows specific items, for example a whiteboard of a meeting room. Configuring the upload rules may include furthermore to which data storage service files having a certain category are to be uploaded. For example, a file comprising work-related content may only be uploaded to a data storage service provided by the company the user is working at. Likewise, a file comprising family related content may only be uploaded to a data storage service having restricted access by family members only. A file comprising content which may be posted to the public may be uploaded to a public data storage service like Facebook or Google, and additionally to the data storage service having restricted access by the family members only. Configuration of the upload rules may be performed once by the user when setting up the user device 10, but maybe modified during the lifetime of the user device 10 if appropriate. Additionally or as an alternative, at least some upload rules may be pre-configured by the manufacturer of the user device 10.

In step 102 the user generates a file. For example, the user may take a picture or video with cameras 14, 15 or record audio information with the microphone 16. Additionally or as an alternative, the user may write a notice or a text document or may make calculations or drawings using the user interface of the user device 10, for example the touchscreen 17. Upon generation of the file by the user, the file is analyzed by searching for the user defined characteristics in step 103. Based on this analysis a category is assigned to the file. Analyzing the file may be performed by a corresponding image, video, audio or text processing software executed by the processing unit 13. The processing unit 13 may have access to user defined information relating to images of family members of colleagues, voice samples of family members and other information needed for characterizing the content of the file.

In case a category could be assigned to the file (step 104), based on the assigned category a corresponding data storage service is assigned in step 105. In step 106 the file is uploaded to the assigned data storage service. In case no category could be assigned to the file (step 104) the file may be stored in the storage unit 12 only, or the user may be requested to assign a category to the file (step 107). Upon assignment of a category by the user, the file may be uploaded as described above in connection with steps 105 and 106.

To sum up, according to the above-described method, filtering rules and limitations, designed by for example the user, are provided to configure automatic upload functionalities in a user device, for example in mobile phones. The method may be implemented as software in the user device to enable the user to improve their control of available automatic upload services. The above-described method may be easily implemented by using existing software functions to analyze the user generated content, but provides a significant user benefit in connection with automatic data upload services.

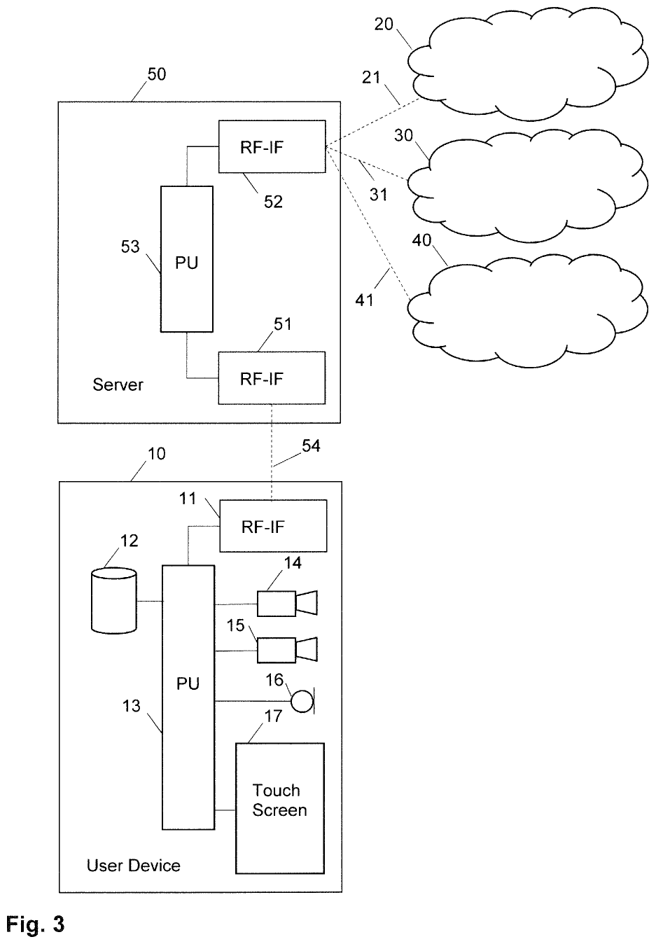

FIG. 3 shows a further example for implementing the above-described method 100. A user device 10 is coupled via a communication connection 54 to a server 50. The user device 10 may comprise the above-described components, for example a transmission interface 11, a storage unit 12, a processing unit 13, a first camera 14, a second camera 15, a microphone 16, and a touchscreen 17. The server 50 comprises a first transmission interface 51 and a second transmission interface 52. The first transmission interface 51 enables the communication to the user device 10, and the second transmission interface 52 enables a communication to data storage services 20, 30, and 40 via corresponding transmission connections 21, 31 and 41, respectively. The server 50 comprises furthermore a processing unit 53.

The processing unit 53 of the server 50 and the processing unit 13 of the user device 10 are configured to perform the method steps 101 to 107 of the method 100 of FIG. 2 as will be described in the following.

In step 101, a user of the user device 10 may configure via a corresponding application upload rules for the automatic upload of user generated content to the data storage services 20, 30 and 40. The upload rules may comprise a definition of characteristics upon which a category is assigned to a user generated content. Upload rules may be transmitted from the user device 10 to the server 50 and stored in the processing unit 53. In step 102 the user generates a file, for example by taking a video or a picture with cameras 14, 15. The generated file is automatically uploaded via the communication connection 54 to the server 50. In the server 50, the file is analyzed by searching for the user defined characteristics in step 103. Based on this analysis, a category is assigned to the file. In case a category could be assigned to the file (step 104), based on the assigned category a corresponding data storage service is assigned in step 105. In step 106 the file is uploaded from the server 50 to the assigned data storage service 20, 30 and/or 40. In case no category could be assigned to the file (step 104), the file may be stored in the server 50 only, or the user may be requested via the user device 10 to assign a category to the file (step 107). Upon assignment of a category by the user, the file may be uploaded as described above from the server 50 to the corresponding data storage services 20, 30 and/or 40.

1. A method for uploading a file from a user device to a data storage service, the method comprising:
assigning a category of a set of categories to the file based on at least one characteristic of the file characterizing a content of the file,
assigning a data storage service from a set of data storage services based on the assigned category, and
uploading the file to the assigned data storage service.

2. The method according to claim 1, wherein the file comprises a file generated at the user device upon operating the user device by a user.

3. The method according to claim 1, wherein the file comprises at least one of a group comprising:
an image file captured by an image capturing unit of the user device,
a video file captured by a video capturing unit of the user device,
an audio file recorded by an audio recording unit of the user device, and
a document file containing information input via a user interface unit of the user device.

4. The method according to claim 1, wherein the at least one characteristic of the file comprises at least one of a group comprising:
a content of an image represented by the file,
a content of a video represented by the file,
a content of an audio recording represented by the file,
a content of textual information represented by the file,
a location information of a geographical location of a generation of the file,
a time and/or date information of a time and/date of a generation of the file, and
a unit information indicating a unit of the user device with which the file was generated.

5. The method according to claim 1, where the set of categories and the corresponding characteristics for assigning the categories are configurable by a user of the user device.

6. The method according to claim 1, wherein the set of data storage services and the corresponding categories for assigning the data storage services are configurable by a user of the user device.

7. The method according to claim 1, wherein the method further comprises, in case no category can be assigned to the file, uploading the file to a default data storage service.

8. The method according to claim 1, wherein the method further comprises, in case no category can be assigned to the file, inhibiting an upload of the file to any one of the set of data storage services.

9. The method according to claim 1, wherein the method further comprises, in case no category can be assigned to the file, storing the file in a storage unit of the user device.

10. The method according to claim 1, wherein the set of categories comprises a no-upload category,
wherein the method further comprises, upon assignment of the no-upload category to the file, inhibiting an upload of the file to any one of the set of data storage services.

11. A user device, comprising:
a transmission interface for communicating with a data storage service,
a storage unit for storing a file, and
a processing unit, configured
to assign a category of a set of categories to the file stored in the storage unit based on at least one characteristic of the file characterizing a content of the file,
to assign a data storage service from a set of data storage services based on the assigned category, and
to upload the file to the assigned data storage service via the transmission interface.

12. The user device according to claim 11, wherein the user device is configured to perform the method according to claim 1.

13. A server, comprising:
a first transmission interface for communicating with a user device,
a second transmission interface for communicating with a data storage service, and
a processing unit, configured
to receive a file from the user device via the first transmission interface,
to assign a category of a set of categories to the file based on at least one characteristic of the file characterizing a content of the file,
to assign a data storage service from a set of data storage services based on the assigned category, and
to upload the file to the assigned data storage service via the second transmission interface.

14. The server according to claim 13, wherein the server is configured to perform the method according to claim 1.
